(19) United States
(12) Patent Application Publication
(10) Pub. No.: US 2026/0168641 A1
(43) Pub. Date: Jun. 18, 2026

(54) VEHICLE LAMP

(71) Applicant: STANLEY ELECTRIC CO., LTD., Tokyo (JP)

(72) Inventor: Norifumi IMAZEKI, Tokyo (JP)

(21) Appl. No.: 19/418,470

(22) Filed: Dec. 12, 2025

(30) Foreign Application Priority Data
Dec. 17, 2024 (JP) 2024-220508

(51) Int. Cl. F21S 43/237; F21S 43/245

(52) U.S. Cl. CPC F21S 43/237; F21S 43/245

(57) ABSTRACT

A vehicle lamp includes light source, and rod-shaped light-guide-body, the light-guide-body has light-guide-part extending from one end side facing the light source toward other end side, light-incidence-part located on the one end side of the light-guide-part, a plurality of reflective cuts located on back surface side of the light-guide-part, and emission-part located on front surface side of the light-guide-part, the light-guide-part has a pair of projection portions located on both sides of central portion on the front surface side of the light-guide-part and that is protruding forward, and the emission-part has first-emission-surface located between the pair of projection portions and curved in convex shape in cross section in direction perpendicular to direction in which the light-guide-part extends, and second-emission-surfaces located on front surface sides of the pair of projection portions and curved in convex shape in the cross section perpendicular to the direction in which the light-guide-part extends.

### CROSS-REFERENCE TO RELATED APPLICATION

Priority is claimed on Japanese Patent Application No. 2024-220508, filed Dec. 17, 2024, the content of which is incorporated herein by reference.

### BACKGROUND OF THE INVENTION

### Field of the Invention

The present invention relates to a vehicle lamp.

### Description of Related Art

In the related art, as a vehicle lamp that is installed in a vehicle, a vehicle lamp that combines a light source such as a light emitting diode (LED) or the like with a plate-or rod-shaped light guide body is known (for example, see Japanese Unexamined Patent Application, First Publication No. 2014-127356).

In such a vehicle lamp, light emitted from the light source enters a base end side of the light guide body, and is guided toward a tip side of the light guide body while repeatedly reflecting the light inside the light guide body. In addition, the light reflected by a plurality of reflective cuts provided on a back surface side of the light guide body is emitted from a front surface side of the light guide body. Accordingly, a light emitting portion provided on the front surface side of the light guide body can emit light in a line or a plane.

For example, Japanese Unexamined Patent Application, First Publication No. 2014-127356 discloses a vehicle lamp including a light guide body disposed to extend in an upward/downward direction, and a light source disposed so that light enters the light guide body from an end surface of the light guide body in the upward/downward direction, the light entering from the end surface being emitted forward from a front surface portion of the light guide body, and the front surface portion of the light guide body having a convex step configured to deflect some of the light guided in the light guide body and emit the light to the side.

### SUMMARY OF THE INVENTION

Incidentally, in the above-mentioned invention disclosed in Japanese Unexamined Patent Application, First Publication No. 2014-127356, by obtaining side illumination light using the light emitted from the convex step, it is possible to ensure a large diffusion angle in the horizontal direction of the light emitted from the light guide body extending in the upward/downward direction.

Meanwhile, with the side deflection emission due to the convex step described above, it is difficult to make the light guide body emit light uniformly in the diffusion direction. That is, the light emitted forward from the front surface portion of the light guide body and the light deflected and emitted to the side from the convex step have different emission directions. Accordingly, with these emitted lights with different emission directions, it is difficult to spread the emission range of the light guide body in the diffusion direction and emit light uniformly.

An aspect of the present invention is directed to providing a vehicle lamp capable of expanding an emission range of a rod-shaped light guide body in a diffusion direction and emitting light more uniformly.

An aspect of the present invention provides the following configurations.
(1) A vehicle lamp including:
a light source; and
a rod-shaped light guide body configured to guide light emitted from the light source,
wherein the light guide body has:
a light guide part extending from one end side facing the light source toward other end side;
a light incidence part that is located on one end side of the light guide part and that is configured to cause the light emitted from the light source to enter an inside of the light guide part;
a plurality of reflective cuts that are located on a back surface side of the light guide part and that are configured to reflect the light guided into the light guide part toward a front surface side of the light guide part; and
an emission part that is located on the front surface side of the light guide part and that is configured to emit the light reflected by the plurality of reflective cuts to an outside of the light guide part,
the light guide part has a pair of projection portions that is located on both sides of a central portion on the front surface side of the light guide part and that is protruding forward, and
the emission part has:
a first emission surface that is located between the pair of projection portions and that is curved in a convex shape in a cross section in a direction perpendicular to a direction in which the light guide part extends; and
second emission surfaces that are located on front surface sides of the pair of projection portions and that are curved in a convex shape in the cross section perpendicular to the direction in which the light guide part extends.
(2) In the vehicle lamp of the above-mentioned (1), the first emission surface is an arc-shaped convex surface with a cross section having a first radius of curvature greater than a reference radius of the light guide part, and
the second emission surface is an arc-shaped convex surface with a cross section having a second radius of curvature smaller than the first radius of curvature.
(3) In the vehicle lamp of the aspect of the above-mentioned (1), in the cross section in the direction perpendicular to the direction in which the light guide part extends, a width of the first emission surface between the pair of projection portions is greater than a width of the reflective cuts.
(4) In the vehicle lamp of the aspect of the above-mentioned (1), the pair of projection portions have connecting surfaces configured to connect an outer end portion of the second emission surface and an outer peripheral surface of the light guide part.
(5) In the vehicle lamp of the aspect of the above-mentioned (4), in the cross section in the direction perpendicular to the direction in which the light guide part extends, the connecting surface is provided so as to be inclined outward by a predetermined angle from a tangent line at a position where the connecting surface is connected to an outer peripheral surface of the light guide part.
(6) In the vehicle lamp of the aspect of the above-mentioned (1), the foremost portion of the second emission surface is located closer to the front surface side than the outer end portion of the second emission surface.
(7) The vehicle lamp of the aspect of the above-mentioned (1) includes a diffusion lens that is disposed on the front surface side of the light guide body and that is configured to diffuse the light emitted from the first emission surface and the second emission surface.

According to the aspect of the present invention, it is possible to provide a vehicle lamp capable of expanding an emission range of a rod-shaped light guide body in a diffusion direction and emitting light more uniformly.

### BRIEF DESCRIPTION OF THE DRAWINGS

FIG. 1 is a perspective view of a vehicle lamp according to an embodiment of the present invention when seen from a front surface side.

FIG. 2 is a perspective view of the vehicle lamp shown in FIG. 1 when seen from a back surface side.

FIG. 3 is a cross-sectional view of a light guide body along a line segment III-III shown in FIG. 1.

FIG. 4 is an optical path diagram of light emitted from the light guide body shown in FIG. 3.

FIG. 5 is an enlarged optical path diagram of an enclosed portion V shown in FIG. 4.

FIG. 6 is a cross-sectional view showing another configuration example of the vehicle lamp.

### DETAILED DESCRIPTION OF THE INVENTION

Hereinafter, an embodiment of the present invention will be described with reference to the accompanying drawings.

Further, in the drawings used in the following description, to make each component easier to see, the dimensions may be displayed at different scales depending on the component, and the dimension ratios of each component may not necessarily be the same as in reality.

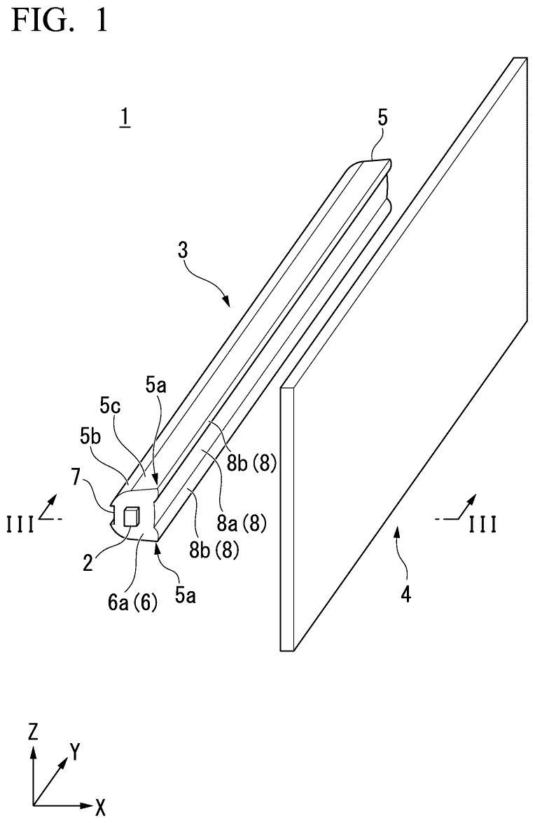

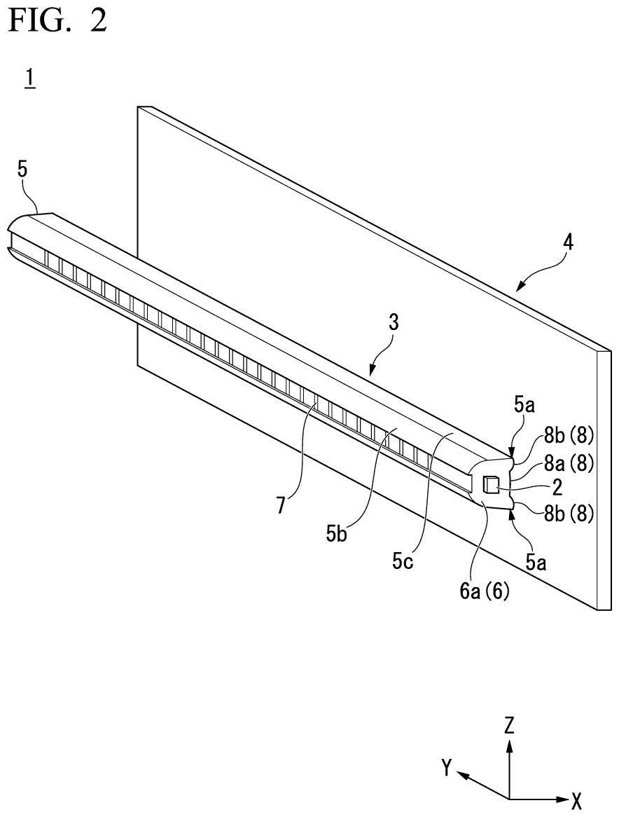

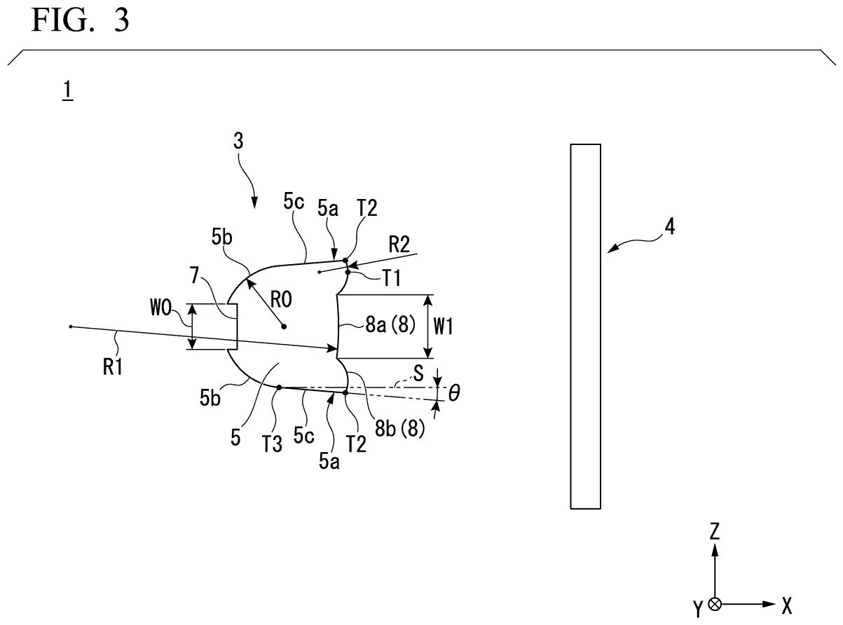

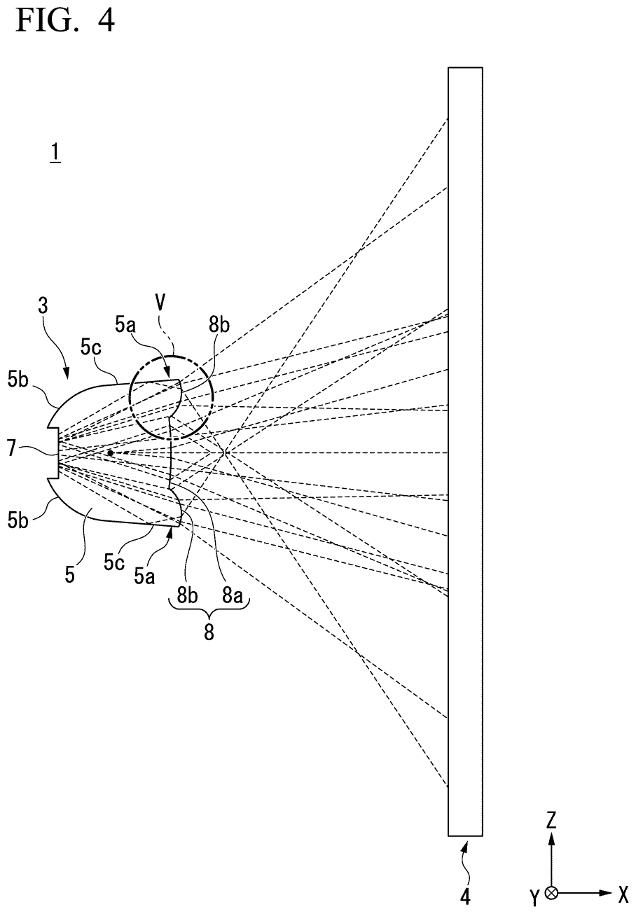

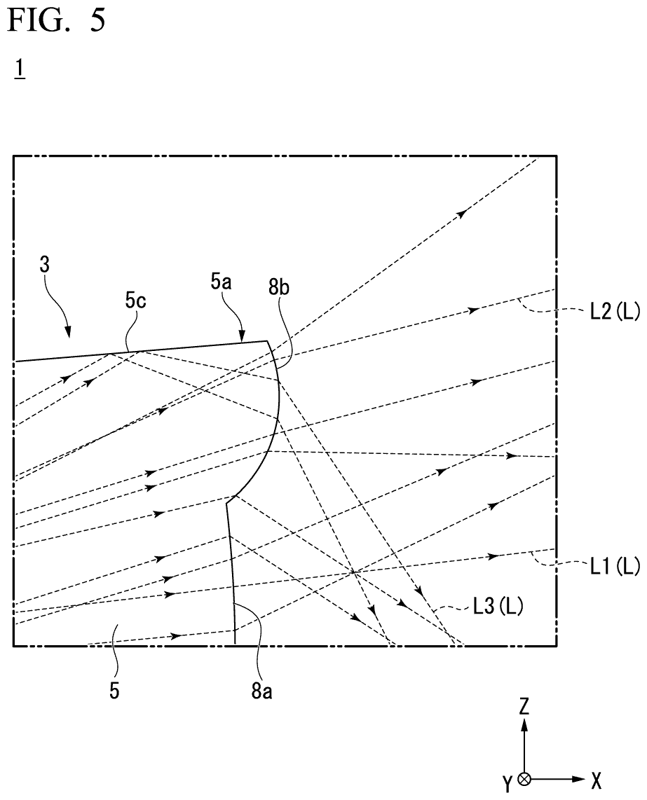

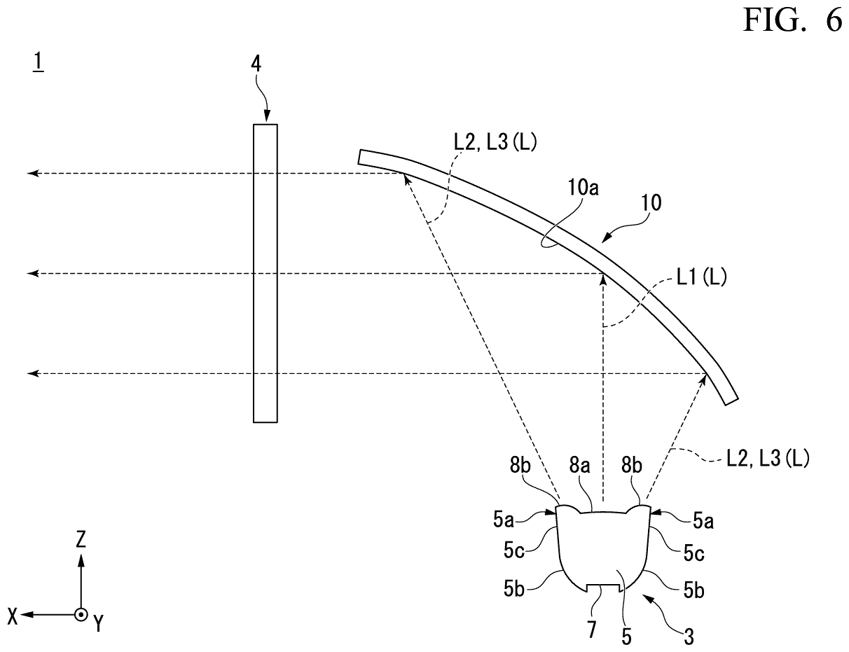

As an embodiment of the present invention, for example, a vehicle lamp 1 shown in FIG. 1 to FIG. 6 will be described. Further, FIG. 1 is a perspective view of the vehicle lamp 1 when seen from a front surface side. FIG. 2 is a perspective view of the vehicle lamp 1 when seen from a back surface side. FIG. 3 is a cross-sectional view of an inner lens 3 along a line segment III-III shown in FIG. 1. FIG. 4 is an optical path diagram of light L emitted from the inner lens 3. FIG. 5 is an enlarged optical path diagram of an enclosed portion V shown in FIG. 4. FIG. 6 is a cross-sectional view showing another configuration example of the vehicle lamp 1.

In addition, in the drawings described below, an XYZ orthogonal coordinate system is set, an X-axis direction indicates a forward/rearward direction of the vehicle lamp 1, a Y-axis direction indicates a leftward/rightward direction of the vehicle lamp 1, and a Z-axis direction indicates an upward/downward direction of the vehicle lamp 1.

As shown in FIG. 1 and FIG. 2, the vehicle lamp 1 of the embodiment includes a light source 2, the inner lens 3, and a diffusion lens 4, and has a structure in which these are disposed inside a lighting body (not shown).

Further, the lighting body is constituted by a housing with a front surface that is open, and an outer lens (cover lens) configured to cover the opening of the housing. Further, the shape of the lighting body can be changed as appropriate to suit the vehicle design, etc.

Further, in addition to the light source 2, the inner lens 3, and the diffusion lens 4 mentioned above, other members such as extensions and brackets can be placed inside the lighting body and attached to the inside of the lighting body.

The light source 2 is constituted by a light emitting diode such as an LED or the like. The light source 2 is mounted on one surface side of a circuit board (not shown) on which a driving circuit (not shown) that drives the light source 2 is mounted, and emits light L radially toward the side (+Y axis side) of the vehicle lamp 1.

As shown in FIG. 1, FIG. 2 and FIG. 3, the inner lens 3 is a rod-shaped light guide body (light guide rod) that guides the light L emitted from the light source 2, and is constituted by a light transmittance member of, for example, a transparent resin such as polycarbonate or acrylic, or glass.

Further, in the embodiment, a direction in which the inner lens 3 extends is along an optical axis of the light L emitted from the light source 2, and corresponds to the leftward/rightward direction of the vehicle lamp 1. In addition, the front surface side of the inner lens 3 corresponds to a front side of the vehicle lamp 1, and the back surface side of the inner lens 3 corresponds to a rear side of the vehicle lamp 1. Further, the diffusion direction of the light L emitted from the inner lens 3 through the front surface side will be described as the upward/downward direction of the vehicle lamp 1.

Further, the inner lens 3 is not limited to being formed in a straight line, and may be at least partially curved. In addition, the orientation of the inner lens 3 can also be changed as appropriate.

The inner lens 3 has a light guide part 5 extending from one end side facing the light source 2 toward the other end side and having a substantially circular cross section, a light incidence part 6 located on one end side of the light guide part 5, a plurality of reflective cuts 7 located on a back surface side of the light guide part 5, and an emission part 8 located on a front surface side of the light guide part 5.

The light guide part 5 is formed in an approximately circular shape overall with a reference radius R0 in a cross section in a direction perpendicular to the direction in which the light guide part 5 extends (hereinafter referred to as a “vertical cross section”). In addition, the light guide part 5 has a pair of projection portions 5a that protrude forward, located on both sides of a central portion of the front surface side thereof. The pair of projection portions 5a have mutually symmetrical shapes and are provided extending from one end side of the light guide part 5 toward the other end side.

The pair of projection portions 5a have connecting surfaces 5c connecting an outer end portion T2 of a second emission surface 8b to an outer peripheral surface 5b of the light guide part 5. The connecting surface 5c is an inclined surface that continues in the direction in which the light guide part 5 extends. Meanwhile, the outer peripheral surface 5b of the light guide part 5, which is closer to the back surface side than the connecting surface 5c, forms an arc-shaped convex surface with a convexly curved cross section having the reference radius R0.

The connecting surface 5c is inclined outward by a predetermined angle θ from a tangent line S at a position T3 where the connecting surface 5c is connected to the outer peripheral surface 5b of the light guide part 5 in the vertical cross section of the light guide part 5. The connecting position T3 between the outer peripheral surface 5b and the connecting surface 5c of the light guide part 5 is located on an upper end and a lower end of the light guide part 5. Accordingly, the tangent line S is parallel to the forward/rearward direction of the vehicle lamp 1 (horizontal direction). In addition, the angle θ of the connecting surface 5 c is preferably 5° to 10°.

Further, the connecting surface 5c is not limited to a surface formed in a straight line (planar surface) in the vertical cross section of the light guide part 5, but may also be a curved surface that is convex or concave.

The light incidence part 6 has a planar incidence surface 6a facing the light source 2 on one end side of the light guide part 5. That is, the incidence surface 6a constitutes a planar surface perpendicular to an optical axis of the light L emitted from the light source 2.

In the light incidence part 6, the light L emitted from the light source 2 enters the inside of the light guide part 5 from the incidence surface 6a. Accordingly, the light L entering from the incidence surface 6a is guided toward the other end side of the light guide part 5 while repeating reflection in the light guide part 5.

The plurality of reflective cuts 7 are, for example, located in the central portion of the back surface side of the light guide part 5, and is configured by approximately triangular groove portions, which are cut out in a direction perpendicular to the direction in which the light guide part 5 extends (upward/downward direction in this embodiment), being arranged in the direction in which the light guide part 5 extends (leftward/rightward direction in this embodiment).

Among the light L that is guided from one end side of the light guide part 5 to the other end side, the plurality of reflective cuts 7 reflects the light which has entered the back surface side of the light guide part 5 toward the emission part 8 located at the front surface side of the light guide part 5.

Further, the plurality of reflective cuts 7 need only reflect the light L entered the back surface side of the light guide part 5 at an angle that causes the light L to emit to the outside from the front surface side of the light guide part 5, and there are no particular limitations on their shape, size, number, etc.

In addition, with regard to the plurality of reflective cuts 7, the intervals between adjacent groove portions forming the reflective cuts 7 may be gradually narrower as it goes from one end side of the light guide part 5 toward the other end side, or the depth of the groove portions forming the reflective cuts 7 may become gradually deeper. Accordingly, the light intensity of the light L directed from one end side of the light guide part 5 toward the other end side can be made closer between one end side and the other end side of the light guide part 5.

The emission part 8 has a first emission surface 8a that is located between the pair of projection portions 5a and that is continuous in the direction in which the light guide part 5 extends, and the second emission surfaces 8b that are located on each front surface side of the pair of projection portions 5a and that are continuous in the direction in which the light guide part 5 extends and adjacent to the first emission surface 8a.

The first emission surface 8a is an arc-shaped convex surface with a convexly curved cross section in the vertical cross section of the light guide part 5. The first emission surface 8a has a first radius of curvature R1 greater than the reference radius R0 of the light guide part 5. In addition, in the vertical end surface of the light guide part 5, a width W1 of the first emission surface 8a in the upward/downward direction is greater than a width W0 of the reflective cuts 7 in the upward/downward direction.

The second emission surface 8b is an arc-shaped convex surface with a convexly curved cross section in the cross section of the light guide part 5. The second emission surface 8b has a second radius of curvature R2 smaller than the first radius of curvature R1. In addition, the foremost portion T1 of the second emission surface 8b is located on the front surface side of the outer end portion T2 of the second emission surface 8b.

As shown in FIG. 3, FIG. 4 and FIG. 5, in the emission part 8, among the light L reflected by the plurality of reflective cuts 7, first light L1 entered the first emission surface 8a is refracted in the diffusion direction toward the diffusion lens 4 in front, and is emitted to the outside of the light guide part 5. Meanwhile, second light L2 entered the second emission surface 8b is refracted in the diffusion direction toward the diffusion lens 4 in front, and is emitted to the outside of the light guide part 5.

In addition, in the emission part 8, among the light L reflected by the plurality of reflective cuts 7, after third light L3 entered the connecting surface 5c is reflected toward the second emission surface 8b, the third light L3 entered the second emission surface 8b is refracted in a wider angle direction than the second light L2 toward the diffusion lens 4 in front, and is emitted to the outside of the light guide part 5.

That is, the third light L3 reflected by the connecting surfaces 5c of the pair of projection portions 5a is emitted from each of the second emission surfaces 8b in directions that intersect with each other, while being refracted and emitted in a wider angle direction than the second light L2 emitted from the second emission surface 8b.

The diffusion lens 4 is constituted by a flat plate-shaped light transmittance member in which a plurality of diffusion cuts (not shown) configured to diffuse the light L (L1, L2, L3) emitted from the first emission surface 8a and the second emission surface 8b is provided, or a flat plate-shaped light diffusion member in which particles with light diffusion properties are dispersed in a transparent resin.

Examples of diffusion cuts include lens cuts referred to as flute cuts and fisheye cuts, and concavo-convex structures formed by knurling or embossing. In addition, by adjusting the shape of the diffusion cuts, it is possible to control the degree of diffusion of the light L.

The diffusion lens 4 transmits the light L emitted from the first emission surface 8a and the second emission surface 8b while diffusing the light L. Accordingly, it is possible to make the front surface side of the diffusion lens 4 emit light more uniformly.

Further, the diffusion lens 4 is not limited to the single lens described above, but may be configured with multiple lenses arranged side by side in the forward/rearward direction.

In the vehicle lamp 1 of the embodiment having the above-mentioned configuration, by diffusing the first light L1 emitted from the first emission surface 8a and the second light L2 and the third light L3 emitted from the second emission surface 8b in the upward/downward directions of the inner lens 3, it is possible to expand the emission range of the inner lens 3 in the diffusion direction. In addition, the first light L1, the second light L2, and the third light L3 emitted in the diffusion direction can cause the diffusion lens 4 to emit light more uniformly.

In addition, in the vehicle lamp 1 of the embodiment, even when the pair of projection portions 5a are provided in the light guide part 5 described above, the diffusion of the light L can be easily controlled by the first emission surface 8a, the second emission surface 8b, and the connecting surface 5c without deteriorating the moldability of the inner lens 3.

As described above, in the vehicle lamp 1 of the embodiment, the inner lens 3, which is constituted by a rod-shaped light guide body, can expand the emission range in the diffusion direction, making it possible to emit light more uniformly.

Further, the present invention is not necessarily limited to the embodiment, and various modifications can be made without departing from the scope of the present invention.

For example, as shown in FIG. 6, the vehicle lamp 1 may have a configuration in which a reflector 10 is disposed between the inner lens 3 and the diffusion lens 4.

The reflector 10 has, for example, a parabola-based concave reflective surface 10a in its vertical cross section and is disposed above the inner lens 3. Meanwhile, the inner lens 3 is disposed in a state in which the emission part 8 faces upward. The diffusion lens 4 is disposed in front of the reflector 10.

The reflector 10 can be, for example, a reflective member having light diffusion properties such as white glass epoxy resin, or a reflective member provided with a reflective film such as an aluminum vapor deposition film or the like.

In the case of this configuration, the light L emitted from the first emission surface 8a and the second emission surface 8b of the inner lens 3 is reflected toward the diffusion lens 4 by the reflective surface 10a of the reflector 10. The light L reflected by the reflective surface 10a of the reflector 10 is diffused by the diffusion lens 4 and transmitted forward.

Even in the case of this configuration, the first light L1 emitted from the first emission surface 8a and the second light L2 and the third light L3 emitted from the second emission surface 8b can expand the emission range of the inner lens 3, which is constituted by the rod-shaped light guide body, in the diffusion direction, making it possible to make the diffusion lens 4 emit light more uniformly. In addition, by using the reflector 10, it is possible to change the positions of the light source 2 and the inner lens 3.

Further, in the configuration shown in FIG. 6, since the optical path lengths from the pair of projection portions 5a to the reflective surface 10a of the reflector 10 are different, the pair of projection portions 5a may be made asymmetrical in shape to match this difference in optical path length, and the shapes of the second emission surface 8b and the connecting surface 5c may be controlled.

Further, the vehicle lamp to which the present invention is applied is not particularly limited, and the present invention can be widely applied to, for example, tail lights (tail lamps), width indicators (position lamps), brake lamps, back lamps, daytime running lights (DRLs), turn signals (blinker lamps), etc.

In addition, the color of the light L emitted by the light source 2 can be changed appropriately depending on the use of the vehicle lamp, such as red light, white light, or orange light.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A vehicle lamp comprising:
a light source; and
a rod-shaped light guide body configured to guide light emitted from the light source,
wherein the light guide body has:
a light guide part extending from one end side facing the light source toward other end side;
a light incidence part that is located on the one end side of the light guide part and that is configured to cause the light emitted from the light source to enter an inside of the light guide part;
a plurality of reflective cuts that are located on a back surface side of the light guide part and that are configured to reflect the light guided into the light guide part toward a front surface side of the light guide part; and
an emission part that is located on the front surface side of the light guide part and that is configured to emit the light reflected by the plurality of reflective cuts to an outside of the light guide part,
the light guide part has a pair of projection portions that is located on both sides of a central portion on the front surface side of the light guide part and that is protruding forward, and
the emission part has:
a first emission surface that is located between the pair of projection portions and that is curved in a convex shape in a cross section in a direction perpendicular to a direction in which the light guide part extends; and
second emission surfaces that are located on front surface sides of the pair of projection portions and that are curved in a convex shape in the cross section perpendicular to the direction in which the light guide part extends.

2. The vehicle lamp according to claim 1, wherein the first emission surface is an arc-shaped convex surface with a cross section having a first radius of curvature greater than a reference radius of the light guide part, and
the second emission surface is an arc-shaped convex surface with a cross section having a second radius of curvature smaller than the first radius of curvature.

3. The vehicle lamp according to claim 1, wherein, in the cross section in the direction perpendicular to the direction in which the light guide part extends, a width of the first emission surface between the pair of projection portions is greater than a width of the reflective cuts.

4. The vehicle lamp according to claim 1, wherein the pair of projection portions have connecting surfaces configured to connect an outer end portion of the second emission surface and an outer peripheral surface of the light guide part.

5. The vehicle lamp according to claim 4, wherein, in the cross section in the direction perpendicular to the direction in which the light guide part extends, the connecting surface is provided so as to be inclined outward by a predetermined angle from a tangent line at a position where the connecting surface is connected to an outer peripheral surface of the light guide part.

6. The vehicle lamp according to claim 1, wherein the foremost portion of the second emission surface is located closer to the front surface side than the outer end portion of the second emission surface.

7. The vehicle lamp according to claim 1, comprising a diffusion lens that is disposed on the front surface side of the light guide body and that is configured to diffuse the light emitted from the first emission surface and the second emission surface.
